(19) United States
(12) Patent Application Publication
(10) Pub. No.: US 2008/0024700 A1
(43) Pub. Date: Jan. 31, 2008

(54) LIQUID CRYSTAL PANEL AND LIQUID CRYSTAL DISPLAY DEVICE

(75) Inventor: Hiroyuki YOSHIMI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/782,329

(22) Filed: Jul. 24, 2007

(30) Foreign Application Priority Data
Jul. 25, 2006 (JP) 2006-202072

(51) Int. Cl. G02F 1/1335

(52) U.S. Cl. 349/96

(57) ABSTRACT

A liquid crystal panel of the present invention has a liquid crystal cell, a visible-side polarizer disposed on the visible-side surface of the liquid crystal cell, and an antivisible-side polarizer disposed on a side opposite to the visible surface of the liquid crystal cell. The visible-side polarizer and the antivisible-side polarizer are disposed so that the absorption axis direction of the visible-side polarizer and the absorption axis direction of the antivisible-side polarizer will be approximately parallel to each other. A polarization rotating layer that rotates linearly polarized light by 90±5 degrees is disposed between the visible-side polarizer and the antivisible-side polarizer.

The liquid crystal panel of the present invention hardly generates warpage of the panel. Therefore, the liquid crystal panel of the present invention can restrain leakage of light in the peripheral part. The liquid crystal panel hardly generating warpage in this manner can restrain leakage of light in the peripheral part even when it is formed into a large screen having a size of 65 inches or more, for example.

### BACKGROUND OF THE INVENTION

1. Field of the Invention

The present invention relates to a liquid crystal panel and a liquid crystal display device.

2. Description of the Related Art

Conventionally, a liquid crystal panel of a liquid crystal display device generally includes a liquid crystal cell, a polarizer disposed on a visible surface side of the liquid crystal cell (the polarizer disposed on the visible surface side may be referred to as a “visible-side polarizer”), a polarizer disposed on a side opposite to the visible surface of the liquid crystal cell (the polarizer disposed on the opposite side may be referred to as an “antivisible-side polarizer”), and an optical compensating layer disposed between the aforesaid two sheets of the polarizers.

The two sheets of the polarizers are arranged in crossed nicol. For example, in a case of a liquid crystal panel of a normally black mode such as a VA (Vertical Alignment) mode or an IPS (In-Plane Switching) mode, the visible-side polarizer is disposed so that the absorption axis direction thereof will be parallel to the longer side of the liquid crystal cell, whereas the antivisible-side polarizer is disposed so that the absorption axis direction thereof will be parallel to the shorter side of the liquid crystal cell. Namely, the visible-side polarizer and the antivisible-side polarizer are arranged so that the absorption axis directions thereof will be perpendicular to each other.

In this case, there has been a limit to the width of the antivisible-side polarizer because of the limitation of the film source width, thereby making it difficult to meet the scale increase of the liquid crystal panel.

In the meantime, in a liquid crystal panel, because of change in the temperature or humidity at the time of use, the optical films disposed on both sides of the liquid crystal cell shrink or expand (hereafter “shrinkage or expansion” will be generally referred to as “expansion-shrinkage”) By this expansion-shrinkage of the optical films, the liquid crystal cell undergoes warpage, and as a result of this, leakage of light or the like is generated.

Conventionally, it is known in the art to prevent warpage of a liquid crystal panel by establishing a predetermined relationship between the thickness of the visible-side polarizing plate and the thickness of the antivisible-side polarizing plate made of a polyvinyl alcohol-based polarizing film provided with a transparent protective layer (Japanese Patent Application Laid-Open No. 2002-207211).

Also, there is known in the art to use in a liquid crystal panel a polarizing plate in which the combined thickness of the polarizer and the protective film is set to be 135 μm or less; a resin layer is provided as an interlayer between the polarizer and the protective film or on the surface of the polarizing plate; and the dimension change ratio in the absorption axis direction is 0.40% or less (Japanese Patent Application Laid-Open No. 2002-372621). All of these means are effective for preventing warpage of the liquid crystal panel.

However, in accordance with the increase in the size of the liquid crystal panel in recent years, the problem of warpage of the liquid crystal panel due to the expansion-shrinkage of the optical films such as the polarizing plate has not yet been sufficiently solved. For this reason, a further improvement is demanded so that the warpage of the liquid crystal panel can be prevented.

### SUMMARY OF THE INVENTION

The first object of the present invention is to provide a liquid crystal panel and a liquid crystal display device capable of restraining leakage of light in the peripheral part by preventing warpage of the liquid crystal panel.

The second object of the present invention is to provide a liquid crystal panel capable of increasing the size of the visible surface, particularly a liquid crystal panel having a size of 65 inches or more.

A liquid crystal panel of the present invention comprise: a liquid crystal cell; a visible-side polarizer disposed on a visible-side surface of the liquid crystal cell; and an antivisible-side polarizer disposed on a side opposite to the visible surface of the liquid crystal cell, wherein the visible-side polarizer and the antivisible-side polarizer are disposed so that an absorption axis direction of the visible-side polarizer and an absorption axis direction of the antivisible-side polarizer will be approximately parallel to each other, and a polarization rotating layer that rotates linearly polarized light by 90±5 degrees is disposed between the visible-side polarizer and the antivisible-side polarizer.

Here, the term “rotation of the polarization plane of linearly polarized light by 90±5 degrees” is used to mean that the polarization plane of the linearly polarized light is rotated in any of the clockwise direction and anticlockwise direction by 90±5 degrees with the line perpendicular to the plane of the polarization rotating layer serving as a central axis.

In the above-described liquid crystal panel, the visible-side polarizer and the antivisible-side polarizer are arranged so that the absorption axis direction of the visible-side polarizer and the absorption axis direction of the antivisible-side polarizer are approximately parallel to each other. For this reason, in accordance with a change in the temperature or humidity at the time of use of the panel, the visible-side polarizer and the antivisible-side polarizer can shrink or expand in the same direction. Therefore, the stress applied to the liquid crystal cell by shrinkage or expansion of the two polarizers is applied in the same direction on both sides of the liquid crystal cell, so that the liquid crystal cell hardly generates warpage.

In particular, a liquid crystal panel having a comparatively large visible surface has also a large area of the polarizers, so that the problem of warpage caused by the expansion or shrinkage of the polarizers is liable to occur. However, the liquid crystal panel of the present invention can effectively prevent warpage of the panel even if it has a comparatively large visible surface.

Here, the visible-side polarizer and the antivisible-side polarizer disposed on both sides of the liquid crystal cell are arranged so that the absorption axis directions thereof are approximately parallel to each other; however, since a polarization rotating layer that rotates linearly polarized light by 90±5 degrees is provided, so that the image displaying function of the liquid crystal panel is in no way hindered.

In other words, linearly polarized light that has passed through the antivisible-side polarizer, for example, is rotated by 90±5 degrees by the polarization rotating layer, so that the linearly polarized light after the rotation will be in crossed-nicol form relative to the absorption axis direction of the visible-side polarizer. Therefore, the linearly polarized light that passes through the antivisible-side polarizer is switched between passage and non-passage through the visible-side polarizer by driving of the liquid crystal cell that has been conventionally used. Therefore, the liquid crystal panel of the present invention can display images by a principle similar to that of the prior art.

A preferable liquid crystal panel of the present invention is such that the aforesaid liquid crystal cell is in a normally black mode such as a VA mode or an IPS mode.

Another preferable liquid crystal panel of the present invention is such that the visible-side polarizer and the antivisible-side polarizer include a stretched film having a main stretching direction in the absorption axis direction.

When the visible-side polarizer and the antivisible-side polarizer include a stretched film in this manner, the visible-side polarizer and the antivisible-side polarizer tend to shrink or expand greatly in the main stretching direction due to change in the temperature or humidity at the time of use. For this reason, warpage is liable to occur in a conventional liquid crystal panel in which the visible-side polarizer made of a stretched film and the antivisible-side polarizer made of a stretched film are arranged so that the absorption axis direction of the visible-side polarizer and the absorption axis direction of the antivisible-side polarizer will be perpendicular to each other. Regarding this point, according to the present invention, warpage of the liquid crystal panel can be effectively prevented by the above-described function even if the two polarizers include a stretched film.

Another preferable liquid crystal panel of the present invention is such that the visible-side polarizer and the antivisible-side polarizer are made of a stretched film containing the same resin as a major component.

When the visible-side polarizer and the antivisible-side polarizer contain the same resin as a major component in this manner, the expansion-shrinkage behaviors of the visible-side polarizer and the antivisible-side polarizer will be similar at the time of use of the panel. Therefore, the warpage of the liquid crystal panel can be prevented with more certainty.

Also, another preferable liquid crystal panel of the present invention is such that the liquid crystal cell is formed in a rectangular shape, the visible-side polarizer and the antivisible-side polarizer include a stretched film having a main stretching direction in the absorption axis direction, and the visible-side polarizer and the antivisible-side polarizer are disposed so that an absorption axis direction of the visible-side polarizer and an absorption axis direction of the antivisible-side polarizer will be approximately parallel to a longer side of the liquid crystal cell.

Such a liquid crystal panel can not only prevent the generation of warpage but also increase the scale of the visible surface size in production.

In other words, a polarizer including a stretched film is obtained by performing a stretching process on a long film source. The absorption axis of such a polarizer is generated in parallel to the stretching direction of the stretched film.

In the liquid crystal panel of the present invention in which the visible-side polarizer and the antivisible-side polarizer are disposed so that the absorption axis direction of the visible-side polarizer and the absorption axis direction of the antivisible-side polarizer will be approximately parallel to the longer side of the liquid crystal cell, the polarizers can be cut out from the film source so that the longitudinal direction of the film source will correspond to the longer side of the liquid crystal panel.

Therefore, the above-described preferable liquid crystal panel will be such that the maximum length of the shorter side of the liquid crystal panel will be the length of the film source in the width direction, so that the visible surface size can be increased to have a greater scale.

Another preferable liquid crystal panel of the present invention is such that the polarization rotating layer is disposed between the liquid crystal cell and the antivisible-side polarizer.

Another preferable liquid crystal panel of the present invention is such that the polarization rotating layer is made of a film of a single layer or plural layers.

Another preferable liquid crystal panel of the present invention is such that the polarization rotating layer is a ½ wavelength plate which has an in-plane retardation value within ½ wavelength±10% for the light with wavelength of 450-650 nm.

Preferably, the ½ wavelength plate has a refractive index property of any one of nx₁>ny₁>nz₁, nx₁>ny₁≅nz₁, and nx₁>nz₁>ny₁.

Here, nx₁ represents a refractive index in an X-axis direction in a plane of the ½ wavelength plate, ny₁ represents a refractive index in a Y-axis direction in the plane, and nz₁ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

Another preferable liquid crystal panel of the present invention is such that the polarization rotating layer has a liquid crystal material that has been subjected to cholesteric orientation, for example, and contains 0.01 to 0.2 parts by weight of a chiral agent with respect to 100 parts by weight of a nematic liquid crystal material.

Another preferable liquid crystal panel of the present invention is such that an optical compensating layer showing a predetermined retardation value is disposed between the visible-side polarizer and the antivisible-side polarizer in addition to the above-described construction. Preferably, the optical compensating layer has a refractive index property of any one of nx₂>ny₂>nz₂, nx₂>ny₂≅nz₂, and nx₂>nz₂>ny₂.

Here, nx₂ represents a refractive index in an X-axis direction in a plane of the optical compensating layer, ny₂ represents a refractive index in a Y-axis direction in the plane, and nz₂ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

Also, according to another aspect of the present invention, a liquid crystal display device has the liquid crystal panel of any one of the above.

### BRIEF DESCRIPTION OF THE DRAWINGS

FIG. 1 is a schematic longitudinal cross-sectional view showing one embodiment of the liquid crystal display device of the present invention;

FIG. 2 is a central part omitted longitudinal cross-sectional view showing one embodiment of the liquid crystal panel of a VA mode;

FIG. 3 is a central part omitted longitudinal cross-sectional view showing one embodiment of the liquid crystal panel of an IPS mode;

FIG. 4 is a reference exploded perspective view showing a construction example of a liquid crystal panel having a polarization rotating layer of a single layer;

FIG. 5 is a reference exploded perspective view showing a construction example of a liquid crystal panel having a polarization rotating layer of two layers;

FIG. 6 is a reference exploded perspective view showing a construction example of a liquid crystal panel having a polarization rotating layer of three layers;

FIG. 7 is a reference perspective view showing a rotation direction of linearly polarized light by a polarization rotating layer; and

FIG. 8A is a reference perspective view showing a fabrication process of a polarizer used in a conventional liquid crystal panel, and FIG. 8B is a reference exploded perspective view showing an arrangement of a liquid crystal cell, a visible-side polarizer, and an antivisible-side polarizer in a conventional liquid crystal panel.

### DETAILED DESCRIPTION OF THE PREFERRED EMBODIMENTS

### <Construction Example of Liquid Crystal Panel>

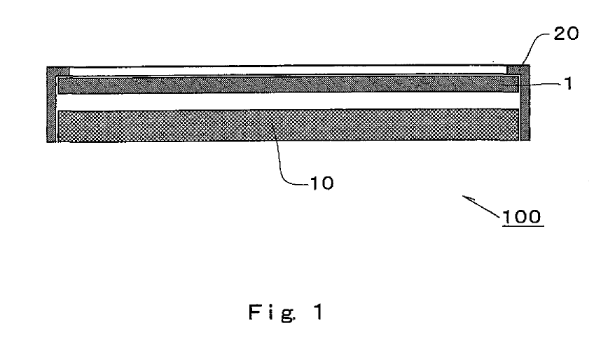

FIG. 1 shows one example of a liquid crystal display device 100 including a liquid crystal panel of the present invention.

The reference numeral 1 represents a liquid crystal panel; the reference numeral 10 represents a light unit disposed to face the liquid crystal panel 1; and the reference numeral 20 represents a bezel disposed around the liquid crystal panel 1.

The light unit 10 is what is known as a back light unit disposed on the opposite side of the liquid crystal panel 1.

Liquid crystal display device can roughly be divided into transmissive type, reflective type and semitransmissive type by the disposition of a light source.

A liquid crystal panel of transmissive type is one in which a light source (a back light) is disposed on the back side of the liquid crystal cell. A liquid crystal panel of transmissive type transmits light of this back light to perform image display. A liquid crystal panel of reflective type is one in which a light source (a front light) is disposed on the visible side of a liquid crystal cell, or a light source (a side light) is disposed on the screen lateral side thereof. A liquid crystal panel of reflective type reflects light of the front light and the like by a reflecting plate to perform image display.

Also, among the liquid crystal panels of reflection type, there is one in which a reflecting electrode is disposed on a substrate, whereby images are displayed by reflecting the light coming from a light source (external fluorescent lamp or solar light) on the visible surface side of the liquid crystal cell.

A liquid crystal panel of semitransmissive type has both of the above-mentioned transmissive type and reflective type together. A liquid crystal panel of semitransmissive type utilizes a light source of the back light in a dark place to perform image display, and meanwhile to reflect solar light in the light to perform image display.

FIG. 1 shows a liquid crystal display device 100 of transmittance type in which the back light 10 is provided. However, the present invention is not limited to transmittance type alone, so that it may be a liquid crystal display device of the above-described reflection type or semi-transmittance type (though not particularly illustrated in the drawings).

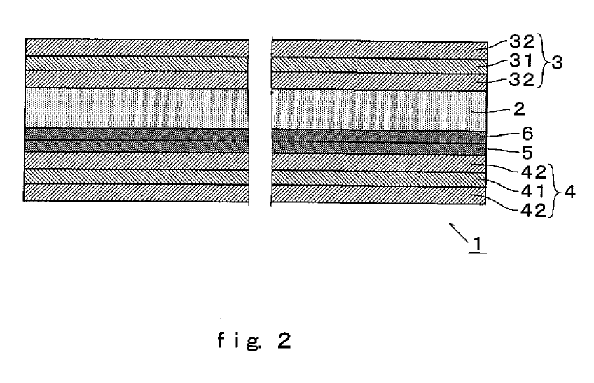

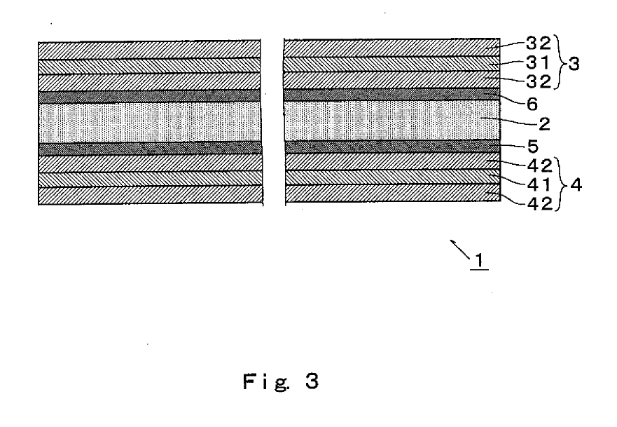

Next, FIGS. 2 and 3 show a construction example of the liquid crystal panel 1 of the present invention. FIG. 2 is one example of a liquid crystal panel of a VA mode, and FIG. 3 is one example of a liquid crystal panel of an IPS mode.

In FIGS. 2 and 3, the reference numeral 1 represents a liquid crystal panel; the reference numeral 2 represents a liquid crystal cell; and the reference numeral 3 represents a visible-side polarizing plate disposed on the visible side of the liquid crystal cell 2. This visible-side polarizing plate 3 includes a polarizer 31 (visible-side polarizer) and protective films 32 laminated on both sides thereof. The reference numeral 4 represents an antivisible-side polarizing plate disposed on the opposite side of the liquid crystal cell. This antivisible-side polarizing plate 4 includes a polarizer 41 (antivisible-side polarizer) and protective films 42 laminated on both sides thereof. The reference numeral 5 represents a polarization rotating layer that rotates linearly polarized light by approximately 90 degrees. The reference numeral 6 represents an optical compensating layer for compensation of a view angle.

In the liquid crystal panel 1 of FIG. 2, the polarization rotating layer is disposed on the opposite side of the liquid crystal cell 2, and the optical compensating layer 6 is disposed as an interlayer between the liquid crystal cell 2 and the polarization rotating layer 5.

In the liquid crystal panel 1 of FIG. 3, the polarization rotating layer 5 is disposed on the opposite side of the liquid crystal cell 2, and the optical compensating layer 6 is disposed as an interlayer between the liquid crystal cell 2 and the visible-side polarizing plate 3.

However, the liquid crystal panel 1 of the present invention is not limited to the constructions shown in FIGS. 2 and 3, so that various changes can be made. For example, the polarization rotating layer 5 may be disposed as an interlayer between the liquid crystal cell 2 and the optical compensating layer 6. Also, the polarization rotating layer 5 may be disposed as an interlayer between the liquid crystal cell 2 and the visible-side polarizing plate 3. Also, one of the two polarization rotating layers 5 may be disposed as an interlayer between the liquid crystal cell 2 and the visible-side polarizing plate 3, and the other one may be disposed as an interlayer between the liquid crystal cell 2 and the antivisible-side polarizing plate 4. Also, one of the two optical compensating layers 6 may be disposed as an interlayer between the liquid crystal cell 2 and the visible-side polarizing plate 3, and the other one may be disposed as an interlayer between the liquid crystal cell 2 and the antivisible-side polarizing plate 4.

Hereafter, each construction member of the liquid crystal panel 1 will be described sequentially.

### <About the Liquid Crystal Cell>

The liquid crystal cell is constructed in such a manner that the visible surface thereof (the visible surface refers to an image displaying surface) is formed to have a rectangular shape as viewed in a front view. Therefore, the lateral length of the visible surface of the liquid crystal panel is formed to be longer that the longitudinal length thereof. The ratio of the lateral and longitudinal lengths of the liquid crystal panel is not particularly limited; however, the ratio is typically such that the lateral length:longitudinal length=4:3, the lateral length:longitudinal length=16:9, or the like.

The size of the visible surface of the liquid crystal cell (namely, the visible surface of the liquid crystal panel) is not particularly limited, so that the present invention can be applied in a wide range from those having a comparatively small visible surface to those having a comparatively large visible surface. Among these, it is effective to apply the present invention to liquid crystal cells having a comparatively large screen. A specific dimension (length of the diagonal line of the visible surface) of such a liquid crystal cell (liquid crystal panel) having a large screen is preferably 65 inches or more, more preferably 80 inches or more, most preferably 100 inches or more.

According to the present invention, such a liquid crystal panel having a comparatively large screen can be produced, and the generation of warpage of the liquid crystal panel can be prevented.

A liquid crystal cell having a conventionally known structure can be used. For example, the liquid crystal cell includes a pair of liquid crystal cell substrates, a spacer interposed between the liquid crystal cell substrates, a liquid crystal layer formed between the pair of liquid crystal cell substrates and having a liquid crystal material injected therein, a color filter disposed on the inner surface of the liquid crystal cell substrate on the visible side, and an electrode element such as a TFT substrate for driving that is disposed on the inner surface of the other liquid crystal cell substrate.

The liquid crystal cell substrates are not particularly limited as long as they are excellent in transparency.

The liquid crystal cell substrates, for example, include transparent glass plates such as soda-lime glass, low-alkali borosilicate glass and no-alkali aluminoborosilicate glass, and transparent flexible plates having flexibility, for example, optical resin plates such as polycarbonate, polymethyl methacrylate, polyethylene terephthalate and epoxy resin.

The liquid crystal material to be injected into the liquid crystal layer is not particularly limited, so that suitable ones can be selected in accordance with the liquid crystal mode. As the liquid crystal mode, a normally black mode, for example, is used such as a VA (Vertical Alignment) mode or an IPS (In-Plane Switching) mode. Among these, a liquid crystal cell of the VA mode is preferable because an extremely high contrast can be achieved.

Here, the normally black mode is a general name for the liquid crystal mode in which the visible surface of the liquid crystal panel becomes a black display (dark display) when voltage is not applied, and the visible surface of the liquid crystal panel becomes a white display (bright display) when voltage is applied.

The VA mode which is one example of the normally black mode is typically such that rod-shaped liquid crystal materials are oriented vertically relative to the liquid crystal cell substrates. The VA mode shuts off the passage of polarized light when voltage is not applied, whereby the visible surface of the liquid crystal panel will be a black display. On the other hand, when voltage is applied, the aforesaid liquid crystal materials fall down to pass the polarized light, whereby the visible surface of the liquid crystal panel will be a white display. Here, the VA mode also includes an MVA (Multi-Domain Vertical Alignment) mode.

The IPS mode which is one example of the normally black mode is typically such that rod-shaped liquid crystal materials are oriented in parallel relative to the liquid crystal cell substrates. The IPS mode shuts off the passage of polarized light when voltage is not applied, whereby the visible surface of the liquid crystal panel will be a black display. On the other hand, when voltage is applied, the aforesaid liquid crystal materials rotate within the plane of the liquid crystal cell substrates to pass the polarized light, whereby the visible surface of the liquid crystal panel will be a white display.

In the case of a liquid crystal cell of a VA mode, the construction of the liquid crystal panel 1 is preferably such that the optical compensating layer 6 is disposed as an interlayer between the liquid crystal cell 2 and the polarization rotating layer 5, as shown in FIG. 2.

On the other hand, in the case of a liquid crystal cell 2 of an IPS mode, the construction of the liquid crystal panel 1 is preferably such that the optical compensating layer 6 is disposed as an interlayer between the liquid crystal cell 2 and the visible-side polarizing plate 3, as shown in FIG. 3.

### <About the Polarizing Plate>

The visible-side polarizing plate includes a polarizer having a function of passing a specific linearly polarized light beam. The visible-side polarizing plate is further preferably such that a protective film is laminated on one surface of the polarizer, and is especially preferably such that a protective film is laminated on both surfaces of the polarizer, as illustrated in the drawings.

Similarly, the antivisible-side polarizing plate includes a polarizer having a function of passing a specific linearly polarized light beam. The antivisible-side polarizing plate is further preferably such that a protective film is laminated on one surface of the polarizer, and is especially preferably such that a protective film is laminated on both surfaces of the polarizer, as illustrated in the drawings.

The polarizer included in the visible-side polarizing plate and the antivisible-side polarizing plate described above is not particularly limited; however, a stretched film having a dichroic substance such as iodine adsorbed thereonto is preferable. In such a polarizer, the absorption axis is formed in a direction parallel to the main stretching direction of the film.

The visible-side polarizing plate and the antivisible-side polarizing plate preferably include polarizers containing the same resin as a major component. Nevertheless, the polarizers may be made of different materials.

Further, because of exhibiting a similar expansion-shrinkage behavior in accordance with a change in the temperature or humidity at the time of use, the polarizer of the visible-side polarizing plate and the polarizer of the antivisible-side polarizing plate are preferably the same (at least having the same resin component and stretching ratio). In particular, the polarizer of the visible-side polarizing plate and the polarizer of the antivisible-side polarizing plate are preferably the same including the polarizers and the protective films.

The visible-side polarizing plate and the antivisible-side polarizing plate are arranged in the liquid crystal cell so that the absorption axis directions of the polarizers thereof will be approximately parallel to each other. Here, the term “approximately parallel” is used to include a meaning that the angle formed by the absorption axis directions of the two polarizers is 0 degrees±5 degrees (preferably 0 degrees±3 degrees). This is because, when the angle formed by the absorption axis directions of the two polarizers is 0 degrees±5 degrees, there will be no hindrance in driving the liquid crystal panel 1 of the present invention.

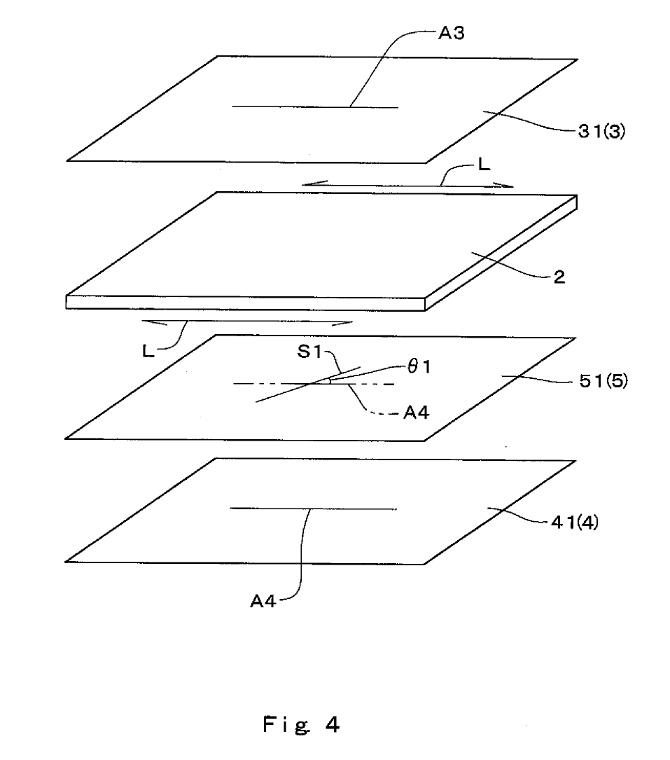

Specifically, referring to FIGS. 4 to 6, in the liquid crystal panel of the present invention, the visible-side polarizing plate 3 and the antivisible-side polarizing plate 4 are disposed so that the absorption axis direction A3 of the visible-side polarizer 31 of the visible-side polarizing plate 3 and the absorption axis direction A4 of the antivisible-side polarizer 41 of the antivisible-side polarizing plate 4 will be approximately parallel to each other. Further, the visible-side polarizing plate 3 and the antivisible-side polarizing plate 4 are disposed so that the absorption axis directions A3, A4 of the two polarizers 31, 41 will be approximately parallel to the longer side direction L of the liquid crystal cell 2. Here, the term “approximately parallel” is used to include a meaning that the angle formed by the longer side direction L and the absorption axis directions A3, A4 is 0 degrees±5 degrees (preferably 0 degrees±3 degrees).

The above-described polarizers are not particularly limited, so that various ones can be used. Examples of the polarizers include a film obtained by allowing a dichroic substance (iodine, a dichroic dye, or the like) to be adsorbed onto a hydrophilic polymer film (polyvinyl alcohol-based film (hereafter, polyvinyl alcohol will be denoted as “PVA”), partially formulated PVA-based film, ethylene-vinyl acetate copolymer-based partially saponified film, or the like) and subjected to monoaxial stretching; a polyene-based oriented film such as dehydrated product of PVA or dehydrochlorinated product of polyvinyl chloride; or the like. Among these, the polarizers are preferably a stretched film obtained by allowing a dichroic substance such as iodine to be adsorbed onto a hydrophilic polymer film (preferably a PVA-based film). The thickness of the polarizers is not particularly limited; however, it is typically about 5 to 80 μm.

A polarizer made of a film obtained by allowing iodine to be adsorbed (dyeing) onto a PVA-based film and subjected to stretching can be produced by a conventionally known method. For example, by immersing a PVA-based film into an aqueous solution of iodine, the film is dyed with iodine. A stretched film obtained by monoaxial stretching of this film to a length 3 times to 7 times as large as the original length is used as the polarizers. In producing the polarizers, the PVA-based film may be immersed into an aqueous solution of potassium iodide optionally containing boric acid, zinc sulfate, zinc chloride, or the like. Further, in accordance with the needs, the PVA-based film may be immersed into water for cleaning with water before the dyeing. By cleaning the PVA-based film with water, the stain or the antiblocking agent on the PVA-based film surface can be removed. Further, by cleaning the PVA-based film with water, the PVA-based film will swell, thereby exhibiting an effect of preventing non-uniformity in dyeing such as unevenness in dyeing. Regarding the above-described stretching, (a) the stretching process may be carried out after dyeing with iodine, or (b) the stretching process may be carried out while dyeing, or (c) the dyeing with iodine may be carried out after the stretching process, or (d) the stretching process may be carried out in an aqueous solution of boric acid, potassium iodide or the like, or in a water bath.

The protective film provided in the polarizer is preferably a film being excellent in transparency, mechanical strength, thermal stability, shielding property against humidity, isotropy, and the like. Examples of the protective film include films of a polyester-based polymer such as polyethylene terephthalate or polyethylene naphthalate; cellulose-based polymer such as diacetylcellulose or triacetylcellulose; acrylic-based polymer such as polymethyl methacrylate; styrene-based polymer such as polystyrene or acrylonitrile-styrene copolymer (AS resin); polycarbonate-based polymer, and the like. Also, the examples include polymer films of polyolefin-based polymer such as polyethylene, polypropylene, polyolefin having a cyclo-based or norbornene structure, or ethylene-propylene copolymer; vinyl chloride-based polymer; amide-based polymer such as nylon or aromatic polyamide; imide-based polymer; sulfone-based polymer; polyethersulfone-based polymer; polyetheretherketone-based polymer; polyphenylene sulfide-based polymer; vinyl alcohol-based polymer; vinylidene chloride-based polymer; vinyl butyral-based polymer; allylate-based polymer; polyoxymethylene-based polymer; epoxy-based polymer; the blended product of these polymers described above; and the like. The protective film can also be formed with a cured layer of thermosetting-type or ultraviolet-setting type resin such as acrylic-based, urethane-based, acrylurethane-based, epoxy-based, or silicone-based.

Further, as the protective film, one can use, for example, a polymer film disclosed in Japanese Patent Application Laid-Open (JP-A) No. 2001-343529. The polymer film is a film including a resin composition containing, for example, (A) a thermoplastic resin having a substituted and/or non-substituted imide group in a side chain and (B) a thermoplastic resin having a substituted and/or non-substituted phenyl group and nitrile group in a side chain. A specific example of this film is a film of a resin composition containing alternate copolymer of isobutylene and N-methylmaleimide and acrylonitrile-styrene copolymer. As the film, those made of a mixed extruded product of the resin compositions or the like can be used.

The thickness of the protective film can be suitably determined. Typically, in view of the operability such as strength and handling property and the thin film property, the thickness of the protective film is about 1 to 500 μm, and preferably 5 to 200 μm.

Also, the protective film is preferably colored to the least extent. Also, a protective film having a retardation value (Rth) of −90 nm to +75 nm in the thickness direction of the film for the visible light at 23° C. is preferably used. By using a film having a retardation value (Rth) of −90 nm to +75 nm in the thickness direction, the coloring (optical coloring) of the polarizing plate due to the protective film can be almost completely eliminated. The retardation value (Rth) in the thickness direction is more preferably −80 nm to +60 nm, and most preferably −70 nm to +45 nm.

Here, the retardation value (Rth) in the thickness direction can be determined as Rth=(nx−nz)×d (where nx is the refractive index of the slow axis direction within the protective film surface; nz is the refractive index in the thickness direction of the protective film; and d is the protective film thickness [nm]).

As the protective film, a cellulose-based polymer film such as triacetylcellulose is preferable in view of the polarization property and the durability. In particular, it is preferable to use triacetylcellulose as the protective film. Here, in the case of disposing a protective film on both sides of the polarizer, it is preferable to use polymer films made of the same material as the two protective films; however, different polymer films may be used as well.

The polarizer and the protective film are bonded typically through the intermediary of a water-based pressure sensitive adhesive or the like. Examples of the water-based pressure sensitive adhesive include isocyanate-based pressure sensitive adhesives, PVA-based pressure sensitive adhesives, gelatin-based pressure sensitive adhesives, vinyl-based latex-based pressure sensitive adhesives, water-based polyurethane pressure sensitive adhesives, water-based polyester pressure sensitive adhesives, and the like.

On the surface of the aforesaid protective film on which the polarizer is not bonded, a hard coat layer may be disposed, or various processes such as antireflection process, antisticking process, or process intended for the purpose of diffusion or antiglaring may be performed.

The hard coat layer is disposed for the purpose of preventing damages to the polarizing plate surface, or the like. The hard coat layer can be formed, for example, by adding a cured coating film being excellent in hardness or sliding property onto the surface of the protective film. Examples of the aforesaid cured coating film include cured films of ultraviolet-setting type resin such as acrylic-based or silicone-based resin, and the like. The antireflection process is carried out for the purpose of preventing reflection of external light on the polarizing plate surface. The antireflection process can be formed by adding an antireflection film similar to conventional ones onto the protective film. Also, the antisticking process is carried out for the purpose of preventing close adhesion to adjacent layers of other members.

Also, the antiglaring process is carried out for the purpose of preventing the visibility hindrance of the light transmitted through the polarizing plate by reflection of external light on the surface of the polarizing plate, or the like. As the antiglaring process, one can cite, for example, means for surface-roughening of the protective film surface by the sandblast method or the emboss-processing method, or means for forming a protective film by blending transparent fine particles into the transparent resin, or the like. With use of these means, a fine bumpy structure can be formed on the surface of the protective film. As the aforesaid transparent fine particles, one can cite, for example, inorganic fine particles (optionally having an electric conductivity in some cases) made of silica, alumina, titania, zirconia, tin oxide, indium oxide, cadmium oxide, antimony oxide, or the like having an average particle diameter of 0.5 μm to 50 μm, organic-based fine particles (including beads) made of a cross-linked or non-cross-linked polymer, or the like. In this case, the amount of use of the transparent fine particles is typically about 2 to 50 parts by weight, preferably 5 to 25 parts by weight, with respect to 100 parts by weight of the transparent resin. The antiglaring process may also serve as a diffusing layer (viewing angle enlarging function or the like).

Here, the antireflection layer, the antisticking layer, the diffusing layer, the antiglaring layer, and the like described above may be disposed on the protective film itself, or these may be applied on another optical film and the optical film may be laminated on the protective film.

### <Polarization Rotating Layer>

The polarization rotating layer is an optical layer having a function of rotating the polarization plane of the linearly polarized light that has passed through the polarizing plate by about 90 degrees with the line perpendicular to the plane of the polarization rotating layer serving as a central axis. Namely, the polarization rotating layer is an optical layer having a function of rotating the linearly polarized light that is incident into the polarization rotating layer so that the light will be in a state of being shifted by about 90 degrees at the time of outgoing. The polarization rotating layer of the present invention is not particularly limited as long as it has this function, so that various ones can be used.

This polarization rotating layer is disposed between the visible-side polarizing plate and the antivisible-side polarizing plate described above.

Here, the term “about 90 degrees” is used to include a meaning of 90 degrees±5 degrees (preferably 90 degrees±3 degrees). This is because, when the linearly polarized light can be rotated by 90 degrees±5 degrees, there will be no hindrance in driving the liquid crystal panel of the present invention.

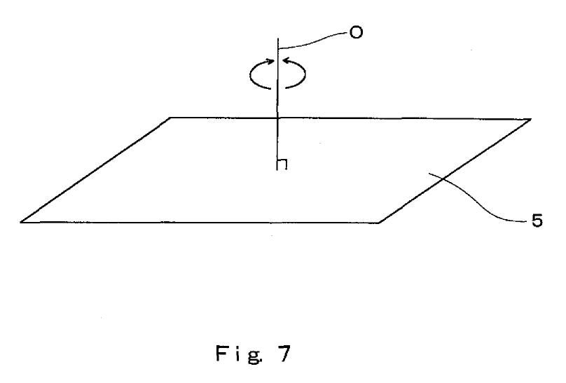

Also, the term “rotation of the polarization plane of linearly polarized light by about 90 degrees” is used to mean that, as shown in FIG. 7, the polarization plane of the linearly polarized light is rotated in any of the clockwise direction and anticlockwise direction by about 90 degrees (including 360 degrees×integers+90 degrees; however, the aforesaid integers include 0) with the line perpendicular to the plane of the polarization rotating layer 5 serving as a central axis O.

The polarization rotating layer may be formed with a single layer, or may be formed with plural layers of two or more layers. Also, the polarization rotating layer may be disposed as an interlayer between the antivisible-side polarizing plate and the liquid crystal cell, or as an interlayer between the visible-side polarizing plate and the liquid crystal cell. Here, in the case where the polarization rotating layer is constructed with plural layers, one or more layers may be disposed between the antivisible-side polarizing plate and the liquid crystal cell, and the remaining one or more layers may be disposed between the visible-side polarizing plate and the liquid crystal cell.

Typically, the polarization rotating layer is bonded onto a constituent member of the liquid crystal panel such as the polarizing plate with use of a suitable pressure sensitive adhesive or adhesive.

As the polarization rotating layer that rotates the linearly polarized light by about 90 degrees (90 degrees±5 degrees), one can cite, for example, (a) a ½ wavelength plate, (b) a layer having a liquid crystal material subjected to cholesteric orientation, and the like layers.

The above (a) ½ wavelength plate has a function of generating a retardation of ½ wavelength in the incident light, and a conventionally known one (a ½ wavelength plate is one kind of the retardation plate) can be used.

The aforesaid ½ wavelength plate preferably has an in-plane retardation value (And) of 120 to 360 nm, more preferably 160 to 320 nm, most preferably 200 to 280 nm, at a temperature of 23° C. and for the wavelength of 550 nm, for example.

Also, preferably, the ½ wavelength plate has a refractive index property of any one of nx₁>ny₁>nz₁, nx₁>ny₁≅nz₁, and nx₁>nz₁>ny₁.

Here, nx₁ represents a refractive index in an X-axis direction in a plane of the ½ wavelength plate, ny₁ represents a refractive index in a Y-axis direction in the plane, and nz₁ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

Also, the in-plane retardation value (And) of the ½ wavelength plate can be determined as Δnd=(nx₁−ny₁)×d₁, where nx₁ and ny₁ have the same meaning as the above-mentioned, and d₁ indicates the thickness [nm] of the ½ wavelength plate.

The material of the ½ wavelength plate is not particularly limited, so that a conventionally known one can be used.

For example, the ½ wavelength plate can be formed with polyolefin (polyethylene, polypropylene, polynorbornene, or the like), amorphous polyolefin, polyimide, polyamideimide, polyamide, polyetherimide, polyetheretherketone, polyetherketone, polyketone sulfide, polyether sulfone, polysulfone, polyphenylene sulfide, polyphenylene oxide, polyethylene terephthalate, polyebutylene terephthalate, polyethylene naphthalate, polyacetal, polycarbonate, polyarylate, polymethylmethacrylate, polymethacrylate, polyacrylate, polystyrene, cellulose-based polymer (triacetylcellose or the like), PVA, epoxy resin, phenol resin, ester resin, acrylate resin, vinyl chloride resin, vinylidene chloride resin, or blended polymer of these.

The ½ wavelength plate can be obtained by forming these resin compositions into a film and performing monoaxial stretching, biaxial stretching, or the like. Also, as the ½ wavelength plate, one can use an oriented film in which a liquid crystalline polymer or a liquid crystalline monomer is oriented.

The aforesaid ½ wavelength plate may be made of a single layer or plural layers of two or more layers.

When a single ½ wavelength plate is used as the polarization rotating layer 5, the ½ wavelength plate 51 may be disposed so that the angle θ1 formed by the slow axis direction S1 of the ½ wavelength plate 51 and the absorption axis direction A4 of the polarizer 41 of the antivisible-side polarizing plate 4 will be about 45 degrees, as shown in FIG. 4. Here, this term “about 45 degrees” is used to include a meaning of 45 degrees±5 degrees (preferably 45 degrees±3 degrees). Also, the slow axis direction refers to an axial direction in which the refractive index attains its maximum within the plane of the ½ wavelength plate.

By laminating the ½ wavelength plate of a single layer in such a configuration, the linearly polarized light that has passed through the antivisible-side polarizing plate (or the visible-side polarizing plate) will become linearly polarized light having its polarization plane rotated by about 90 degrees.

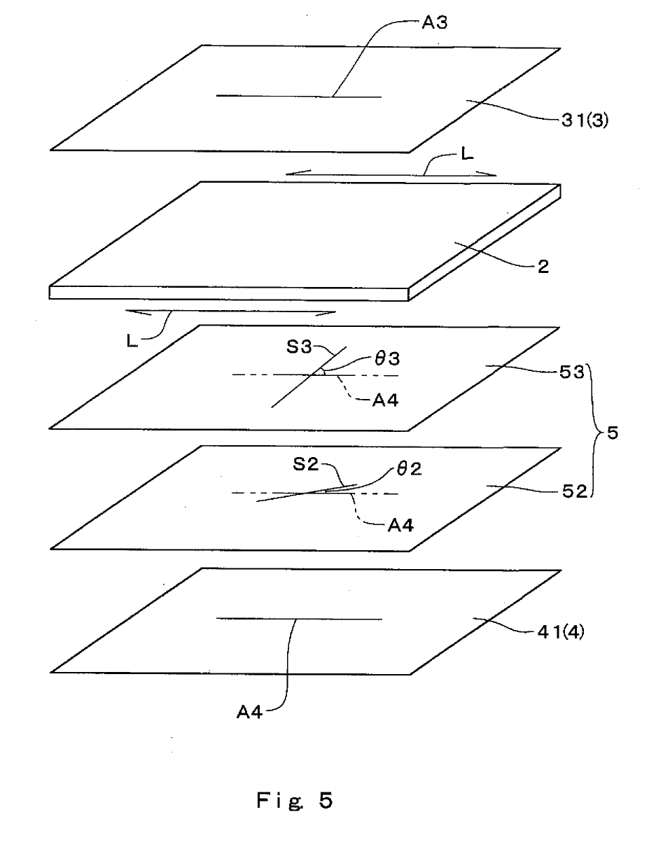

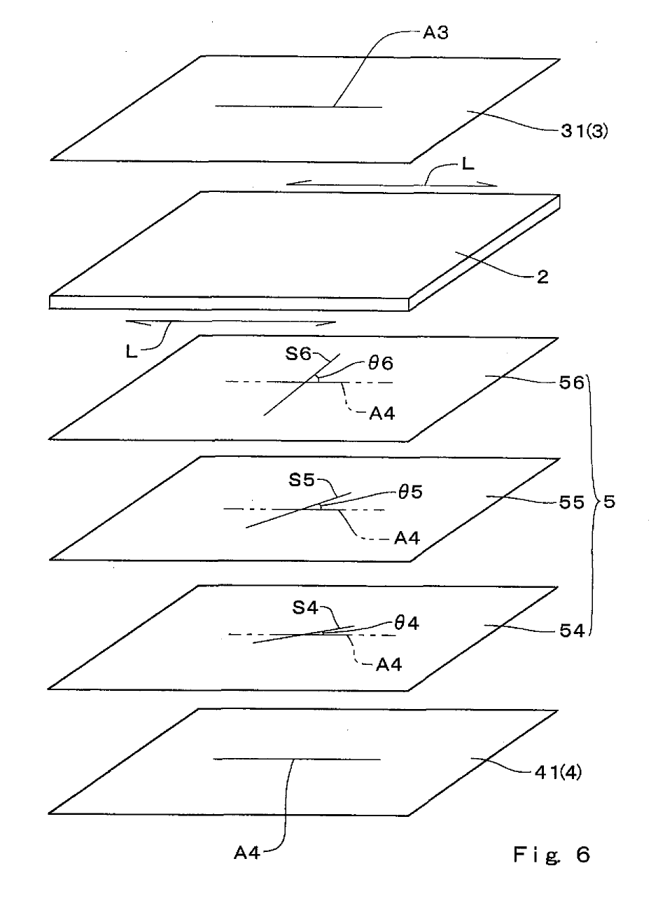

Here, in FIG. 4, the aforesaid angle θ1 shows a case in which the slow axis direction S1 of the ½ wavelength plate 51 is tilted in an anticlockwise direction as viewed from the visible surface side; however, the slow axis direction S1 of the ½ wavelength plate 51 may be tilted in a clockwise direction (the same applies to the angles θ2, θ3, θ4, θ5, and θ6 in FIGS. 5 and 6 shown in the following).

Also, when a ½ wavelength plate of two layers is used as the polarization rotating layer 5, the ½ wavelength plate 52 of the first layer is disposed so that the angle θ2 formed by the slow axis direction S2 of the ½ wavelength plate 52 of the first layer and the absorption axis direction A4 of the polarizer 41 of the antivisible-side polarizing plate 4 will be about 22.5 degrees, as shown in FIG. 5. Further, the ½ wavelength plate 53 of the second layer is disposed so that the angle θ3 formed by the slow axis direction S3 of the ½ wavelength plate 53 of the second layer and the absorption axis direction A4 of the polarizer 41 of the antivisible-side polarizing plate 4 will be about 67.5 degrees. Here, the term “about” is used to include a meaning of ±5 degrees (preferably ±3 degrees) in the same manner as shown above.

By laminating the ½ wavelength plate of two layers in such a configuration, the linearly polarized light that has passed through the antivisible-side polarizing plate (or the visible-side polarizing plate) will become linearly polarized light having its polarization plane rotated by about 90 degrees.

Further, when a ½ wavelength plate of three layers is used as the polarization rotating layer 5, the ½ wavelength plate 54 of the first layer is disposed so that the angle θ4 formed by the slow axis direction S4 of the ½ wavelength plate 54 of the first layer and the absorption axis direction A4 of the polarizer 41 of the antivisible-side polarizing plate 4 will be about 15 degrees, as shown in FIG. 6. Further, the ½ wavelength plate 55 of the second layer is disposed so that the angle θ5 formed by the slow axis direction S5 of the ½ wavelength plate 55 of the second layer and the absorption axis direction A4 of the polarizer 41 of the antivisible-side polarizing plate 4 will be about 45 degrees. Further, the ½ wavelength plate 56 of the third layer is disposed so that the angle θ6 formed by the slow axis direction S6 of the ½ wavelength plate 56 of the third layer and the absorption axis direction A4 of the polarizer 41 of the antivisible-side polarizing plate 4 will be about 75 degrees. Here, the term “about” is used to include a meaning of ±5 degrees (preferably ±3 degrees) in the same manner as shown above.

By laminating the ½ wavelength plate of three layers in such a configuration, the linearly polarized light that has passed through the antivisible-side polarizing plate (or the visible-side polarizing plate) will become linearly polarized light having its polarization plane rotated by about 90 degrees.

Next, the aforesaid (b) polarization rotating layer having a liquid crystal material subjected to cholesteric orientation has a function of rotating the polarization plane of the linearly polarized light because the liquid crystal material assumes a spiral structure.

Such a polarization rotating layer can be exemplified by those obtained by forming a compound containing a nematic liquid crystal material (liquid crystal material in which the liquid crystal phase is a nematic phase) and a chiral agent into a film form.

As the liquid crystal material, it is preferable to use polymerizable nematic liquid crystal monomers represented by the following general formula (I), for example. These liquid crystal monomers may be used either as one kind or as two or more kinds in combination.

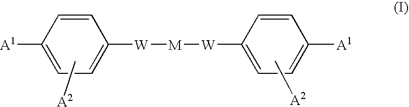

In the general formula (I), A¹ and A² each represent a polymerizable group, and may be the same or different. Also, one of A¹ and A² may be hydrogen. The groups W each represent a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR; and R in the aforesaid W represents H or C₁ to C₄ alkyl; and M represents a mesogenic group.

In the general formula (I), two groups W may be the same or different; however, the two are preferably the same. Also, the two groups A² are each preferably configured in the ortho-position relative to A¹.

Further, A¹ and A² in the general formula (I) are preferably each independently represented by the following general formula (II).

Z-W-(Sp)n General formula (II)

In the general formula (II), Z represents a cross-linking group; W is the same as those in the above general formula (I); Sp represents a spacer composed of straight-chain or branched-chain alkyl group having 1 to 30 carbon atoms; and n represents 0 or 1. The carbon chain in the above Sp may be intervened with oxygen in an ether functional group, sulfur in a thioether functional group, a non-adjacent imino group, an alkylimino group of C₁ to C₄, or the like.

The groups A¹ and A² in the above general formula (I) are preferably the same group. Also, Z in the general formula (II) is preferably any one of the atomic groups represented by the following formula (III). In the formula (III), R may be, for example, a group such as methyl, ethyl, n-propyl, i-propyl, n-butyl, i-butyl, t-butyl, or the like.

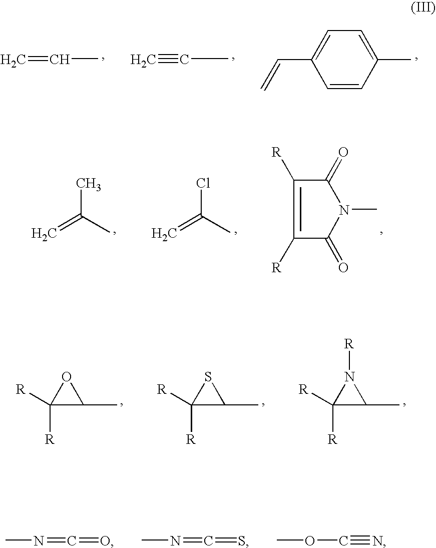

Also, in the aforesaid general formula (II), Sp is preferably any one of the atomic groups represented by the following general formula (IV). In the following general formula (IV), q is preferably 1 to 3; and p is preferably 1 to 12.

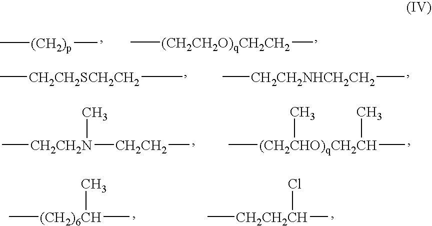

Also, in the above general formula (I), M is preferably a group represented by the following general formula (V). In the general formula (V), W is the same as W in the above general formula (I). The group Q represents, for example, a substituted or nonsubstituted alkylene or aromatic hydrocarbon atomic group, and may be substituted or nonsubstituted, straight-chain or branched-chain, C₁ to C₁₂ alkylene, or the like.

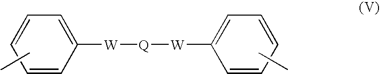

In the case where the above Q is an aromatic hydrocarbon atomic group, Q is preferably an atomic group such as represented by the following general formula (VI) or a substitution analog thereof for example.

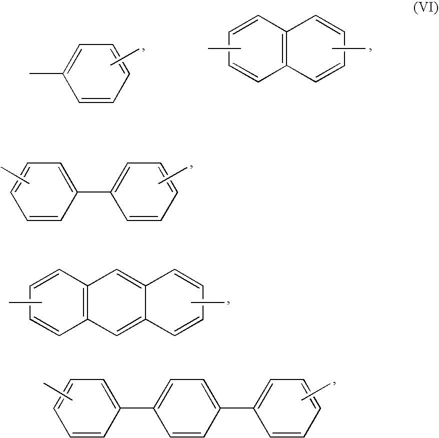

The substitution analog of an aromatic hydrocarbon atomic group represented by the above general formula (VI) may have 1 to 4 substituent groups per one aromatic ring, and may have 1 or 2 substituent groups per one aromatic ring or group. These substituent groups may each be the same or different. Examples of these substituent groups include C₁ to C₄ alkyl, nitro, halogen such as F, Cl, Br and I, phenyl, C₁ to C4 alkoxy, and the like.

Specific examples of the liquid crystal monomers described above in detail are, for example, monomers represented by the following structural formulas (2) to (17).

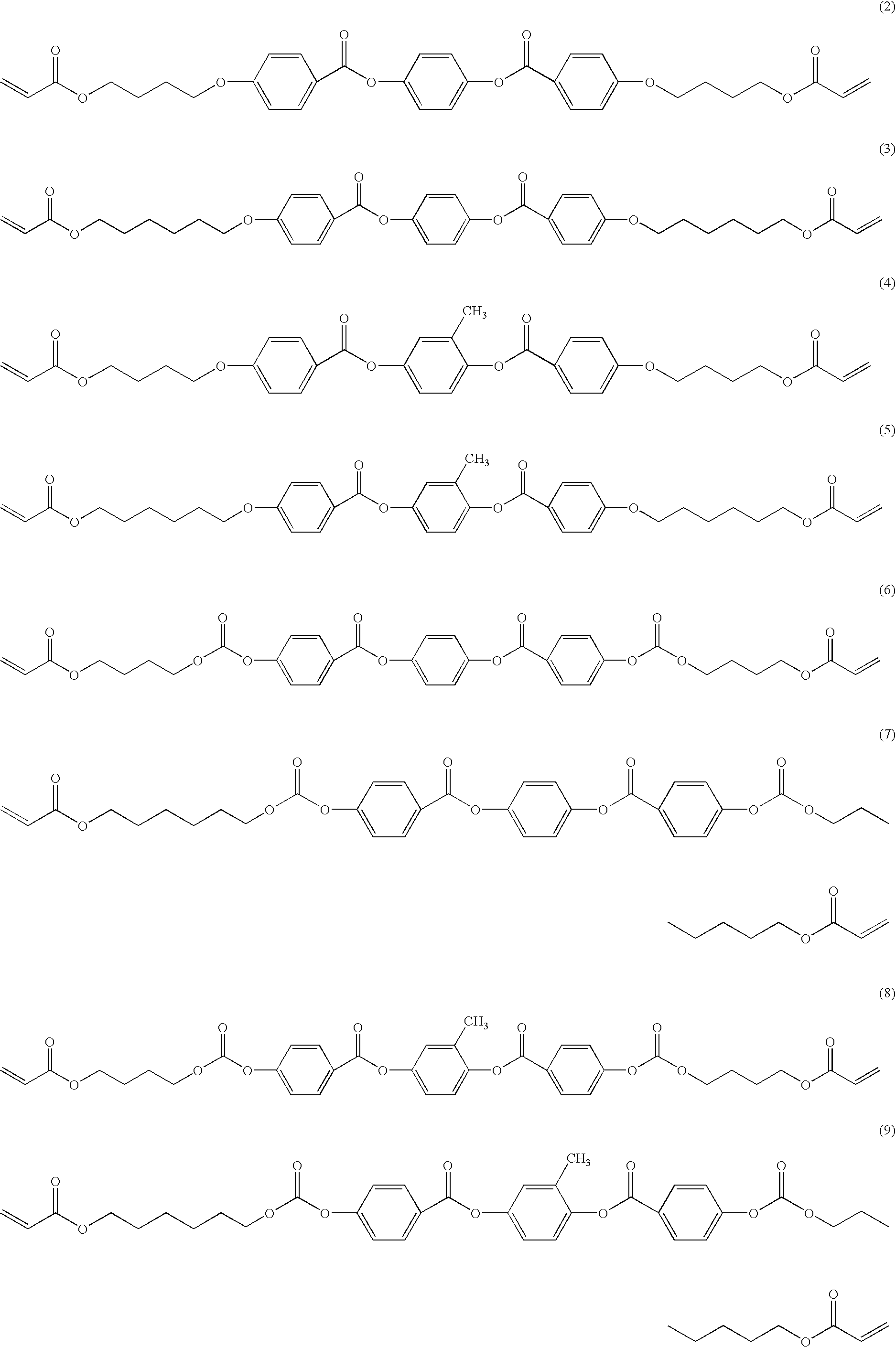

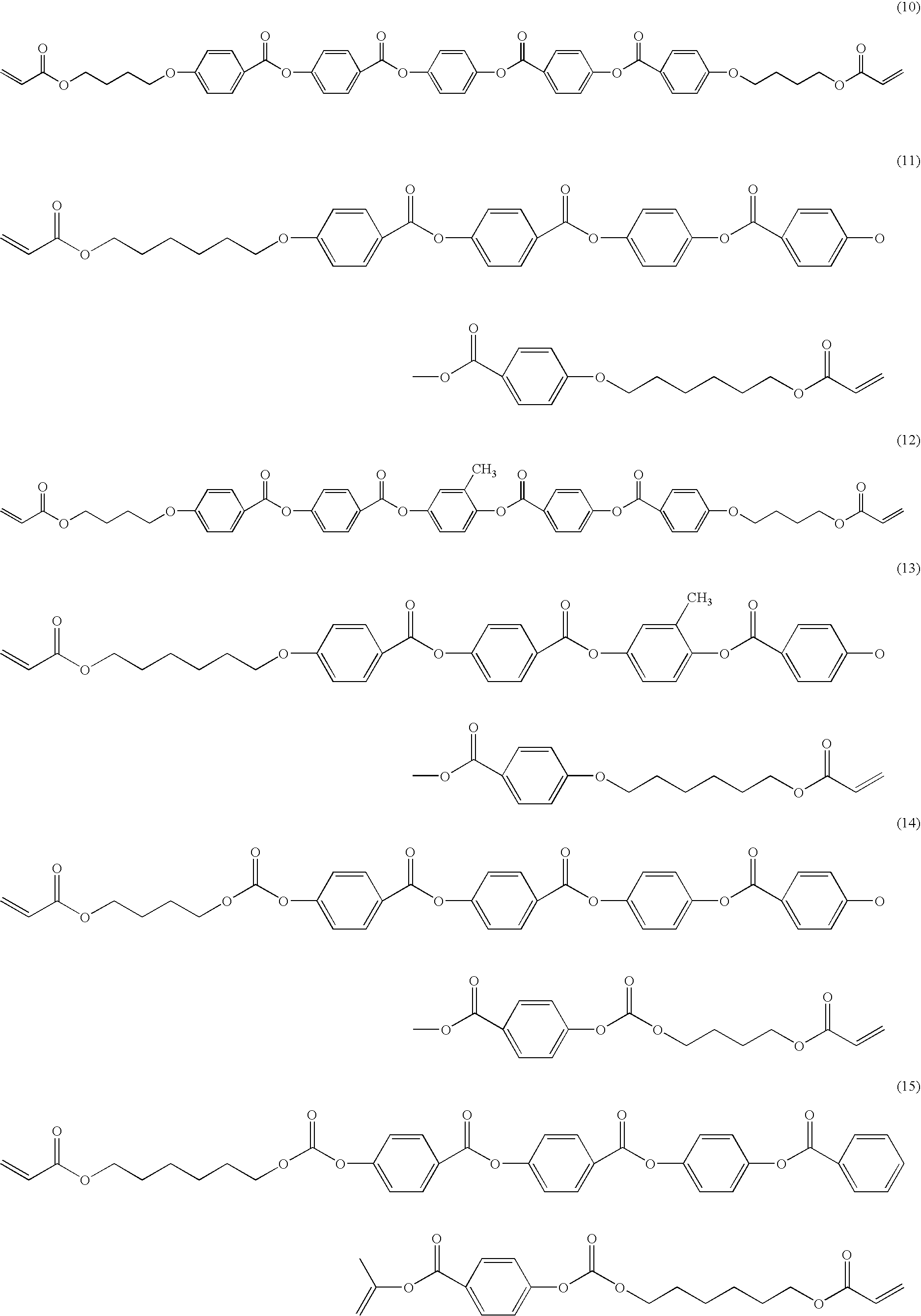

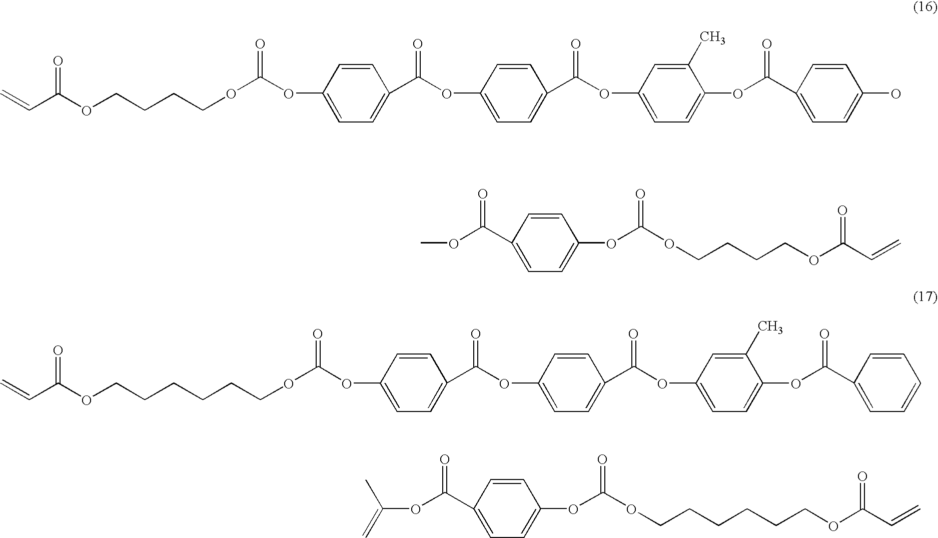

The temperature range in which the above-described liquid crystal monomer exhibits liquid crystallinity may differ depending on the kind thereof; however, the temperature range is preferably, for example, a range from 40 to 120° C., more preferably a range from 50 to 100° C., and most preferably a range from 60 to 90° C.

Also, the chiral agent is not particularly limited as long as it is, for example, one capable of imparting a twist to the liquid crystal monomer to orient the liquid crystal monomer so as to form a cholesteric structure. As the chiral agent, it is preferable to use a polymerizable chiral agent. These chiral agents may be used either as one kind or as two or more kinds in combination.

As a specific example of the chiral agent, one can suitably use those disclosed in Japanese Patent Application Laid-Open (JP-A) No. 2003-287623, [0049] to [0056].

The polymerizing agent and the cross-linking agent for polymerizing the liquid crystal monomer are not particularly limited; however, one such as the following can be used. As the aforesaid polymerizing agent, one can use, for example, benzoyl peroxide (BPO), azobisisobutyronitrile (AIBN), or the like. As the aforesaid cross-linking agent, one can use, for example, an isocyanate-based cross-linking agent, an epoxy-based cross-linking agent, a metal chelate cross-linking agent, or the like. These may be used either as one kind or as two or more kinds in combination.

Application liquid is prepared by dissolving and dispersing a liquid crystal monomer, a chiral agent, a polymerizing agent, and the like into a suitable solvent, and this is applied onto a suitable oriented substrate to form a layer.

Here, a method of forming a layer including the aforesaid liquid crystal monomer and chiral agent is described in detail in Japanese Patent Application Laid-Open (JP-A) No. 2003-287623, [0057] to [0072] and the like, so that one may carry out the process in accordance therewith.

The ratio of blending the aforesaid nematic liquid crystal material and chiral agent is not limited as long as the layer (polarization rotating layer) obtained from these assumes a cholesteric structure capable of rotating linearly polarized light by about 90 degrees. Specifically, it is preferable that 0.01 to 0.2 parts by weight of the chiral agent is contained with respect to 100 parts by weight of the nematic liquid crystal material; and further it is more preferable that 0.02 to 0.15 parts by weight of the chiral agent is contained; and it is most preferable that 0.03 to 0.1 parts by weight of the chiral agent is contained.

### <About the Optical Compensating Layer>

The optical compensating layer is constructed with a birefringent layer exhibiting a predetermined retardation. The optical compensating layer is also referred to as a retardation plate.

The optical compensating layer is provided in a liquid crystal panel for the purpose of improving the view angle characteristics, and a conventionally known one can be suitably selected for use.

As the optical compensating layer, one can use an optical compensating layer in which the refractive index (nz₂) in the thickness direction is smaller than the refractive index (nx₂, ny₂) in the plane (nx₂≅ny₂>nz₂), an optical compensating layer in which the refractive index (nz₂) in the thickness direction is larger than the refractive index (nx₂, ny₂) in the plane (nx₂≅ny₂<nz₂), or other optically monoaxial optical compensating layers (nx₂>ny₂≅nz₂). Also, one can use optically biaxial optical compensating layers (nx₂>ny₂>nz₂, nx₂>nz₂>ny₂, and the like) as well.

Here, nx₂ represents a refractive index in an X-axis direction in a plane of the optical compensating layer, ny₂ represents a refractive index in a Y-axis direction in the plane, and nz₂ represents a refractive index in a direction perpendicular to said X-axis direction and Y-axis direction. The X-axis direction is an axis direction in which the refractive index attains a maximum value in the plane, and the Y-axis direction is a direction perpendicular to an X-axis in the plane.

In the case where the liquid crystal cell of the liquid crystal panel of the present invention is in a VA mode, it is preferable to use one layer of an optically biaxial optical compensating layer of nx₂>ny₂>nz₂, or a combination of one layer of an optical compensating layer of nx₂≅ny₂>nz₂ and one layer of an optical compensating layer of nx₂>ny₂≅nz₂.

On the other hand, in the case where the liquid crystal cell is in an IPS mode, it is preferable to use one layer of an optical compensating layer of nx₂>nz₂≧ny₂, or a combination of one layer of an optical compensating layer of nx₂≅ny₂<nz₂ and one layer of an optical compensating layer of nx₂>ny₂≧nz₂, or a combination of one layer of an optical compensating layer of nx₂≅ny₂>nz₂ and one layer of an optical compensating layer of nx₂≧nz₂>ny₂.

The material for forming the optical compensating layer is not particularly limited, so that a conventionally known one can be used. As a standard for selecting the material for forming the optical compensating layer, it is preferable to select a material with which the birefringence index at the time of forming the optical compensating layer will be a relatively high value. Also, the optical compensating layer is preferably optically biaxial because it can realize a wide view angle property. Also, when the optical compensating layer is applied to a liquid crystal panel of the VA mode, the optical compensating layer preferably has an Nz coefficient (as determined by Nz=(nx₂−nz₂)/(nx₂−ny₂)) of 2 to 20.

As the material for forming the optical compensating layer, one can cite, for example, a birefringent film obtained by monoaxial or biaxial stretching of a non-liquid-crystalline polymer, an oriented film of a liquid crystal polymer, one in which the oriented layer of the liquid crystal polymer is supported with a film, or the like. The thickness of the optical compensating layer is also not particularly limited; however, a thickness of about 1 to 150 μm is typical. The optical compensating layer may be a single layer, or one may use two or more layers exhibiting optical characteristics that are different from each other or of the same kind. The optical compensating layer is bonded onto a polarizing plate or the like with use of a suitable pressure sensitive adhesive or adhesive.

As the aforesaid non-liquid-crystalline polymer, one can cite, for example, polyesters such as PVA, polyvinylbutyral, polymethyl vinyl ether, polyhydroxyethyl acrylate, hydroxyethyl cellulose, hydroxypropylcellulose, methyl cellulose, polycarbonate, polyallylate, polysulfone, and polyethylene terephthalate, and polymers such as polyether ketone, polyether sulfone, polyphenylene sulfide, polyphenylene oxide, polyallylsulfone, polyamideimide, polyesterimide, polyamide, polyimide, polyolefin, polyvinyl chloride, cellulose-based polymer, norbornene-based polymer, or two-dimensional or three-dimensional various copolymers, graft copolymers, and blended products of these. These polymer materials are made into an oriented product (stretched film) by stretching or the like.

As the aforesaid liquid crystal polymer, one can cite, for example, main-chain type or side-chain type various ones in which a conjugate linear atomic group (mesogenic) imparting a liquid crystal orientation is introduced into a main chain or a side chain of the polymer. As a specific example of the liquid crystal polymer of main chain type, one can cite, for example, one having a structure in which a mesogenic group is bonded to a spacer part that imparts a bending property (for example, a polyester-based liquid crystalline polymer having a nematic orientation property, discotic polymer, cholesteric polymer, or the like). A liquid crystal polymer of side chain type has a main chain skeleton and a side chain. The main chain skeleton may be polysiloxane, polyacrylate, polymethacrylate, polymalonate, or the like. The side chain may be those having a mesogenic part made of para-substituted cyclic compound units having a nematic orientation imparting property through the intermediary of a spacer part made of a conjugate atomic group, or the like. These liquid crystal polymers are prepared in a solution form. The liquid crystal polymer solution is, for example, developed onto an orientated base material and subjected to thermal treatment to be formed into a film. As the aforesaid oriented base material, one can cite, for example, those in which the surface of a thin film such as polyimide or PVA formed on a glass plate is subjected to a rubbing treatment, an orientation-treated surface having silicon oxide obliquely vapor-deposited, or the like.

The optical compensating layer is preferably formed with a non-liquid-crystalline polymer. Unlike a liquid crystalline material, the non-liquid-crystalline polymer can form a film exhibiting an optically monoaxial property of nx₂>nz₂, ny₂>nz₂ by its own nature. For this reason, the base material used in fabricating an optical compensating layer is not limited to an oriented base material, so that a non-oriented base material can be used as well. As compared with an oriented base material, a non-oriented base material can omit a process of applying an orientation film, a process of laminating an orientation film, or the like. For this reason, when the protective film laminated on the polarizer is used as a base material used for forming the optical compensating layer, the optical compensating layer can be formed directly on the protective film without the use of a pressure sensitive adhesive.

The optical compensating layer used in the above-described liquid crystal cell of the VA mode preferably includes a polyimide-based film exhibiting an optically biaxial property (nx₂>ny₂>nz₂ or the like).

The polyimide is preferably a polyimide having a high in-plane orientation property and being soluble in an organic solvent, for example. Specifically, as the polyimide, one can use, for example, a polymer containing a condensation polymerization product of 9,9-bis(aminoaryl)fluorene with aromatic tetracarboxylic acid dianhydride which is disclosed in Japanese Patent Application Laid-Open (JP-A) No. 2000-511296 and containing one or more repetition units represented by the following formula (VII).

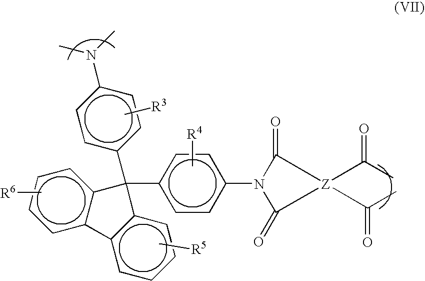

In the formula (VII), R³ to R⁶ are at least one kind of substituent groups that are each independently selected from the group consisting of hydrogen, halogen, phenyl group, phenyl group substituted with 1 to 4 halogen atoms or C₁ to C₁₀ alkyl groups, and C₁ to C₁₀ alkyl groups. Preferably, R³ to R⁶ are at least one kind of substituent groups that are each independently selected from the group consisting of halogen, phenyl group, phenyl group substituted with 1 to 4 halogen atoms or C₁ to C₁₀ alkyl groups, and C₁ to C₁₀ alkyl groups.

In the formula (VII), Z is, for example, a C₆ to C₂₀ tetravalent aromatic group, preferably a pyromellitic group, polycyclic aromatic group, a derivative of polycyclic aromatic group, or a group represented by the following formula (VIII).

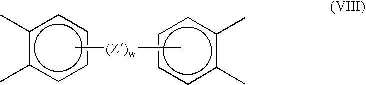

In the formula (VIII), Z′ is, for example, a covalent bond, C(R⁷)₂ group, CO group, oxygen, sulfur, SO₂ group, Si(C₂H₅)₂ group, or NR⁸ group, and, in the case where plural Z′ are present, they are respectively the same or different. Also, w represents an integer from 1 to 10. R⁷ are respectively independently hydrogen or C(R⁹)₃. R⁸ is hydrogen, alkyl group having a carbon atom number of 1 to about 20, or C₆ to C₂₀ aryl group, and, in the case where plural R⁸ are present, they are respectively the same or different. R⁹ are respectively independently hydrogen, fluorine, or chlorine.

As the polycyclic aromatic group, one can cite, for example, a tetravalent group derived from naphthalene, fluorene, benzofluorene, or anthracene. Also, as the substituted derivative of the aforesaid polycyclic aromatic group, one can cite, for example, the aforesaid polycyclic aromatic group substituted with at least one group selected from the group consisting of C₁ to C₁₀ alkyl group, a fluorinated derivative thereof, and halogen such as fluorine and chlorine.

In addition to the above, one can cite, for example, a homopolymer having a repetition unit represented by the following general formula (IX) or (X), a polyimide having a repetition unit represented by the following general formula (XI), or the like, which are disclosed in Japanese Patent Application Laid-Open (JP-A) No. 08-511812. Here, the polyimide of the following formula (XI) is a preferable mode of the homopolymer of the following formula (IX).

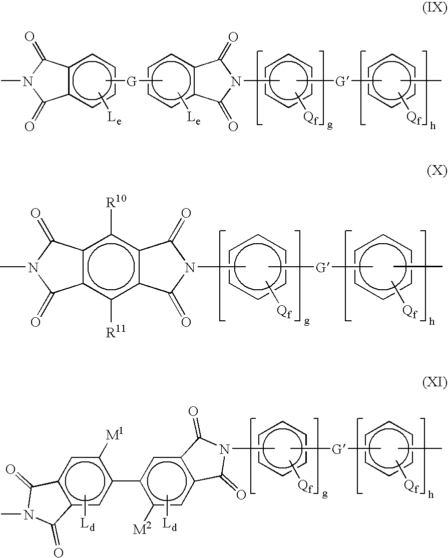

In the general formulas (IX) to (XI), G and G′ represent, for example, a covalent bond or a group respectively independently selected from the group consisting of CH₂ group, C(CH₃)₂ group, C(CF₃)₂ group, C(CX₃)₂ group (X is halogen), CO group, oxygen, sulfur, SO₂ group, Si(CH₂CH₃)₂ group, and N(CH₃) group, and may be respectively the same or different.

In the formula (IX) and the formula (XI), L is a substituent group, and d and e represent the number of substitutions thereof. The group L is, for example, a halogen, C₁ to C₃ alkyl group, C₁ to C₃ halogenated alkyl group, phenyl group, or substituted phenyl group, and, in the case where plural L are present, they are respectively the same or different. As the aforesaid substituted phenyl group, one can cite, for example, a substituted phenyl group having at least one kind of a substituent selected from the group consisting of halogen, C₁ to C₃ alkyl group, and C₁ to C₃ halogenated alkyl group. Also, as the aforesaid halogen, one can cite, for example, fluorine, chlorine, bromine, or iodine. The number d is an integer from 0 to 2, and the number e is an integer from 0 to 3.

In the formulas (IX) to (XI), Q is a substituent group, and f represents the number of substitutions thereof. The group Q is, for example, an atom or a group selected from the group consisting of hydrogen, halogen, alkyl group, substituted alkyl group, nitro group, cyano group, thioalkyl group, alkoxy group, aryl group, substituted aryl group, alkylester group, and substituted alkylester group, and, in the case where plural Q are present, they are respectively the same or different. As the aforesaid halogen, one can cite, for example, fluorine, chlorine, bromine, and iodine. As the aforesaid substituted alkyl group, one can cite, for example, a halogenated alkyl group. Also, as the aforesaid substituted aryl group, one can cite, for example, a halogenated aryl group. The number f is an integer from 0 to 4, and the number g is an integer from 0 to 3, and the number h is an integer from 1 to 3. Also, the numbers g and h are preferably greater than 1.

In the formula (X), R¹⁰ and R¹¹ are groups respectively independently selected from the group consisting of hydrogen, halogen, phenyl group, substituted phenyl group, alkyl group, and substituted alkyl group. Among these, it is preferable that R¹⁰ and R¹¹ are respectively independently a halogenated alkyl group.

In the formula (XI), M¹ and M² are the same or different, and are, for example, a halogen, C₁ to C₃ alkyl group, C₁ to C₃ halogenated alkyl group, phenyl group, or substituted phenyl group. As the aforesaid halogen, one can cite, for example, fluorine, chlorine, bromine, and iodine. As the aforesaid substituted phenyl group, one can cite, for example, a substituted phenyl group having at least one kind of a substituent selected from the group consisting of halogen, C₁ to C₃ alkyl group, and C₁ to C₃ halogenated alkyl group.

Specific examples of the polyimide shown in the formula (IX) are, for example, those represented by the following formula (XII), and the like.

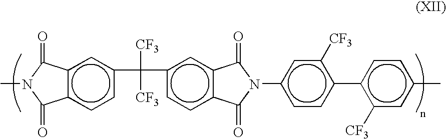

Further, as the aforesaid polyimide, one can cite, for example, a copolymer obtained by suitable copolymerization of acid dianhydride or diamine other than the skeleton (repetition units) described before.

As the acid dianhydride, one can cite, for example, aromatic tetracarboxylic acid dianhydride. As the aromatic tetracarboxylic acid dianhydride, one can cite, for example, pyromellitic acid dianhydride, benzophenonetetracarboxylic acid dianhydride, naphthalenetetracarboxylic acid dianhydride, heterocyclic aromatic tetracarboxylic acid dianhydride, 2,2′-substituted biphenyltetracarboxylic acid dianhydride, and the like.

As the diamine, one can cite, for example, aromatic diamine and, as specific examples, one can cite benzenediamine, diaminobenzophenone, naphthalenediamine, heterocyclic aromatic diamine, and other aromatic diamines.

The aforesaid polyimide is formed into a film by a conventionally known method, and the obtained film can be used as an optical compensating layer. For example, one can cite dissolving polyimide into a suitable solvent and forming a film on a suitable base material film.

It is preferable that the above-described optical compensating layer used in the liquid crystal cell of IPS mode contains, for example, a norbornene-based film exhibiting an optically biaxial property (nx₂>nz₂>ny₂ or the like).

As the norbornene-based resin, one can cite, for example, an open-ring (co)polymer of norbornene-based monomer; a denatured polymer of these obtained by further adding maleic acid, cyclopentadiene, or the like; a resin obtained by further hydrogenating of these; resin obtained by addition polymerization of norbornene-based monomer, and the like. Here, the aforesaid open-ring (copolymer of norbornene-based monomer includes resin obtained by hydrogenation of an open-ring copolymer of one or more kinds of norbornene-based monomers and α-olefins and/or cycloalkenes and/or non-conjugate dienes. Also, the aforesaid resin obtained by addition copolymerization of norbornene-based monomer includes resin obtained by addition-type copolymerization of one or more kinds of norbornene-based monomers and α-olefins and/or cycloalkenes and/or non-conjugate dienes.

The aforesaid norbornene-based film is preferably a stretched film containing a resin obtained by hydrogenation of an open-ring (co)polymer of norbornene-based monomer.

Further preferably, it is a stretched film of norbornene-based film containing a resin obtained by hydrogenation of an open-ring (co)polymer of norbornene-based monomer in which a part or whole of the constituent units have a structure represented by the following general formula (XIII), the following formula (XIV), and/or the following formula (XV).

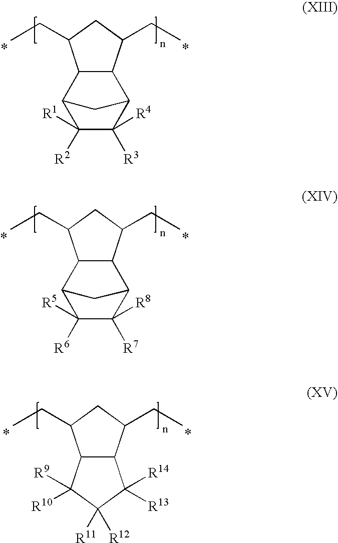

In the general formulas (XIII), (XIV), and (XV), R¹ to R¹⁴ are a substituent selected from the group consisting of hydrogen atom, halogen atom, halogenated alkyl group, C₁-C₄ alkyl group, C₁-C₄ alkylidene group, C₁-C₄ alkenyl group, C₁-C₄ alkoxycarbonyl group, aryl group, aralkyl group, aralkyloxy group, hydroxyalkyl group, cyano group, C₄-C₁₀ cycloalkyl group, acyloxy group, and substituted derivatives thereof, and are respectively the same or different. The number n is an integer of 2 or more.

Especially preferably, in the general formula (XIII), R¹ to R⁴ are a substituent selected from the group consisting of hydrogen atom, halogen atom, halogenated alkyl group, C₁-C₄ alkyl group, C₁-C₄ alkylidene group, C₁-C₄ alkenyl group, C₁-C₄ alkoxycarbonyl group, aryl group, aralkyl group, aralkyloxy group, C₄-C₁₀ cycloalkyl group, and acyloxy group, and are respectively the same or different. The number n is an integer of 2 or more. Also, especially preferably, in the general formula (XIV), R⁵ to R⁸ are a substituent selected from the group consisting of hydrogen atom, halogen atom, halogenated alkyl group, C₁-C₄ alkyl group, C₁-C₄ alkylidene group, C₁-C₄ alkenyl group, and C₁-C₄ alkoxycarbonyl group, and are respectively the same or different. The number n is an integer of 2 or more. Also, especially preferably, in the general formula (XV), R⁹ to R¹⁴ are a substituent selected from the group consisting of hydrogen atom and C₁-C₄ alkyl group, and are respectively the same or different. The number n is an integer of 2 or more.

Most preferably, in the general formula (XIII), R¹ and R² are a substituent selected from the group consisting of hydrogen atom, trifluoromethyl group, methyl group, ethyl group, methylidene group, ethylidene group, vinyl group, propenyl group, methoxycarbonyl group, ethoxycarbonyl group, phenyl group, ethylphenyl group, benzoyloxy group, and cyclohexyl group, and are respectively the same or different. R³ and R⁴ are a hydrogen atom. The number n is an integer of 2 or more. Also, most preferably, in the general formula (XIV), R⁵ and R⁶ are a substituent selected from the group consisting of hydrogen atom, trifluoromethyl group, methyl group, ethyl group, methylidene group, ethylidene group, vinyl group, propenyl group, methoxycarbonyl group, and ethoxycarbonyl group, and are respectively the same or different. R⁷ and R⁸ are a hydrogen atom. The number n is an integer of 2 or more. Also, most preferably, in the general formula (XV), R⁹ to R¹² are a hydrogen atom and/or methyl group, and are respectively the same or different. R¹³ and R¹⁴ are a hydrogen atom. The number n is an integer of 2 or more.

In the liquid crystal panel of the present invention, the visible-side polarizer and the antivisible-side polarizer are provided in the liquid crystal cell so that the absorption axis direction of the visible-side polarizer and the absorption axis direction of the antivisible-side polarizer are approximately parallel to each other. For this reason, in accordance with a change in the temperature or humidity at the time of use of the panel, the visible-side polarizer and the antivisible-side polarizer can shrink or expand in the same direction. Therefore, the stress applied to the liquid crystal cell by shrinkage or expansion of the two polarizers will be in the same direction on both sides of the liquid crystal cell. As a result of this, warpage of the liquid crystal panel can be prevented.

In particular, a liquid crystal panel having a comparatively large displaying surface generally has also a large area of the polarizers, so that the problem of warpage caused by the expansion or shrinkage of the polarizers is liable to occur. However, the liquid crystal panel of the present invention can effectively prevent warpage of the liquid crystal panel even if it has a comparatively large displaying surface.

Also, in the liquid crystal panel of the present invention, the visible-side polarizer and the antivisible-side polarizer disposed on both sides of the liquid crystal cell are arranged so that the absorption axis directions thereof are approximately parallel to each other, so that the two polarizers will not be in a crossed-nicol form. Regarding this point, since a polarization rotating layer that rotates linearly polarized light by 90±5 degrees is provided between the visible-side polarizer and the antivisible-side polarizer, the image displaying function of the liquid crystal panel is in no way hindered.

Specifically, for example, by taking as an example a liquid crystal panel of the present invention in which the polarization rotating layer is provided between the antivisible-side polarizer and the liquid crystal cell, and this is equipped with a back light, the linearly polarized light that has passed through the antivisible-side polarizer will have its polarization plane rotated by 90±5 degrees by entering the polarization rotating layer. In other words, the linearly polarized light that has passed through this polarization rotating layer will be in crossed-nicol form relative to the absorption axis of the visible-side polarizer. The linearly polarized light that has passed through the polarization rotating layer will be linearly polarized light that is parallel or perpendicular to the absorption axis direction of the visible-side polarizer by driving of the liquid crystal cell conventionally known in the art. Therefore, the image displaying function of the liquid crystal panel is in no way hindered.

Further, the liquid crystal panel of the present invention can overcome the limit in increasing the visible surface size accompanying the restrictions in production.

Specifically, the polarizer containing a stretched film or the polarizer made of a stretched film is produced by stretching a hydrophilic polymer film on which a dichroic substance such as iodine is adsorbed, as described above.

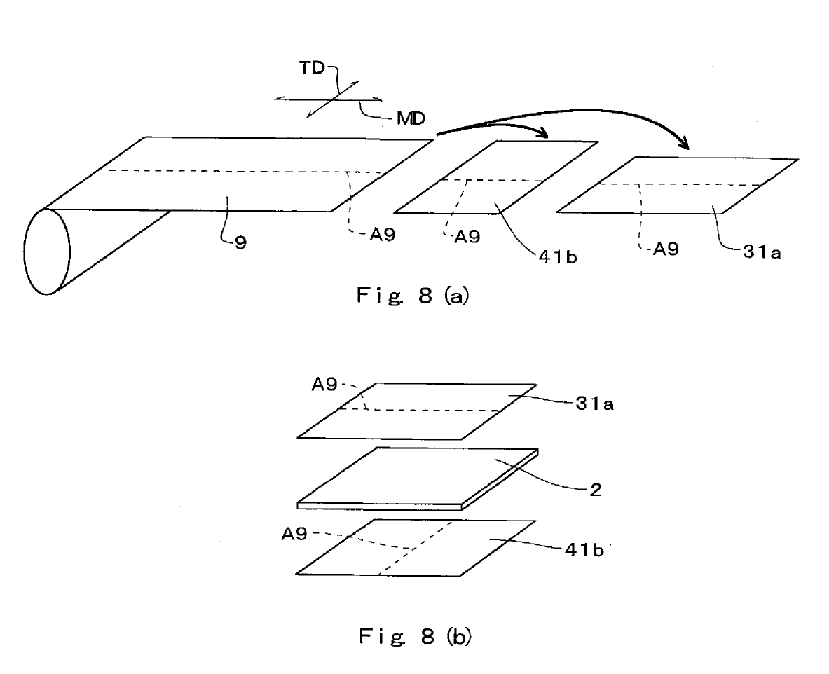

In producing this mechanically, a source film is drawn out from an extremely long film source roll having a predetermined width, and a dichroic substance is adsorbed, followed by stretching in the longitudinal direction (MD direction). The film source 9 after the stretching process will generate an absorption axis direction A9 in the stretching direction (namely, MD direction), as shown in FIG. 8A.

In a conventional liquid crystal panel, the visible-side polarizer and the antivisible-side polarizer are arranged so that the absorption axis direction of the visible-side polarizer and the absorption axis direction of the antivisible-side polarizer will be perpendicular to each other. For example, the visible-side polarizer is disposed so that the absorption axis direction thereof will be parallel to the longer side of the liquid crystal cell, and the antivisible-side polarizer is disposed so that the absorption axis direction thereof will be parallel to the shorter side of the liquid crystal cell.

Then, referring to FIG. 8A, the two polarizers 31a, 41a disposed in the liquid crystal cell having a rectangular visible surface can be obtained by cutting the film source 9 after the above-described stretching process into a rectangular shape in accordance with the shape of the visible surface.

The antivisible-side polarizer 41a disposed so that the absorption axis thereof will be parallel to the shorter side of the liquid crystal cell can be obtained by cutting the film source 9 so that the width direction (TD direction) thereof will be the longer side of the antivisible-side polarizer.

Therefore, the length of the longer side of the visible surface of the conventional liquid crystal panel (liquid crystal cell 2) corresponds to the longer side of the antivisible-side polarizer 41b, namely, the length of the film source 9 in the width direction, as shown in FIG. 8B. For this reason, the maximum length of the longer side of the visible surface of the conventional liquid crystal panel has been restricted by the length of the film source 9 in the width direction, and this has been a limit of the size of the visible surface of the liquid crystal panel.

In the present invention, the absorption axis direction of the visible-side polarizer and the absorption axis direction of the antivisible-side polarizer are arranged to be parallel to each other. The two polarizers can be obtained by cutting the above-described film source so that the longitudinal direction of the film source will be the longer side of the two rectangular polarizers in accordance with the shape of the visible surface.

Therefore, the longer side of the visible surface of the liquid crystal panel of the present invention corresponds to the longitudinal direction of the film source, and also the shorter side of the visible surface of the liquid crystal panel will be the length of the film source in the width direction.

Therefore, since the maximum length of the shorter side of the liquid crystal panel of the present invention will be the length of the film source in the width direction, the size of the visible surface can be increased in scale as compared with a conventional liquid crystal panel.

Therefore, the present invention can provide a liquid crystal panel having a visible surface of 65 inches or more.

### <About the Liquid Crystal Display Device>

The liquid crystal panel of the present invention can be preferably used for forming a liquid crystal display device or the like. Formation of the liquid crystal display device can be carried out in accordance with the prior art. Namely, the liquid crystal display device is formed typically by suitably assembling a liquid crystal panel and construction components such as an illumination system, or the like process. The liquid crystal display device of the present invention is not particularly limited except that the aforesaid liquid crystal panel is used, so that it can be fabricated according to the prior art.

The liquid crystal display device of the present invention is used for arbitrary purposes. The use thereof is directed, for example, to OA appliance such as personal computer monitors, notebook personal computers, and copying machines, portable appliance such as portable phones, watches, digital cameras, portable information terminals (PDA), and portable game machines, electric appliance for home use such as video cameras, television sets, and electronic ranges, appliance for mounting on a vehicle such as back monitors, monitors for a car navigation system, and car audio apparatus, display appliance such as monitors for information for commercial stores, safeguard appliance such as supervising monitors, assisting or medical appliance such as monitors for assisting and caring seniors and monitors for medical use, and the like appliance.

What is claimed is:

1. A liquid crystal panel comprising:
a liquid crystal cell;
a visible-side polarizer disposed on a visible-side surface of the liquid crystal cell; and
an antivisible-side polarizer disposed on a side opposite to the visible surface of the liquid crystal cell, wherein
the visible-side polarizer and the antivisible-side polarizer are disposed so that an absorption axis direction of the visible-side polarizer and an absorption axis direction of the antivisible-side polarizer will be approximately parallel to each other, and
a polarization rotating layer that rotates linearly polarized light by 90±5 degrees is disposed between the visible-side polarizer and the antivisible-side polarizer.

2. The liquid crystal panel of claim 1, wherein an angle formed by the absorption axis direction of the visible-side polarizer and the absorption axis direction of the antivisible-side polarizer is 0 degrees±5 degrees.

3. The liquid crystal panel of claim 1, wherein the liquid crystal cell is in a normally black mode.

4. The liquid crystal panel of claim 3, wherein the liquid crystal cell is in a VA mode or in an IPS mode.

5. The liquid crystal panel of claim 1, wherein the visible-side polarizer and the antivisible-side polarizer include a stretched film having a main stretching direction in the absorption axis direction.

6. The liquid crystal panel of claim 4, wherein the visible-side polarizer and the antivisible-side polarizer include a stretched film having a main stretching direction in the absorption axis direction.

7. The liquid crystal panel of claim 6, wherein the visible-side polarizer and the antivisible-side polarizer are made of a stretched film containing the same resin as a major component.

8. The liquid crystal panel of claim 1, wherein
the liquid crystal cell is formed in a rectangular shape,
the visible-side polarizer and the antivisible-side polarizer include a stretched film having a main stretching direction in the absorption axis direction, and
the visible-side polarizer and the antivisible-side polarizer are disposed so that an absorption axis direction of the visible-side polarizer and an absorption axis direction of the antivisible-side polarizer will be approximately parallel to a longer side of the liquid crystal cell.

9. The liquid crystal panel of claim 1, wherein the liquid crystal cell has a size of 65 inches or more.

10. The liquid crystal panel of claim 1, wherein the polarization rotating layer is disposed between the liquid crystal cell and the antivisible-side polarizer.

11. The liquid crystal panel of claim 1, wherein the polarization rotating layer is made of a film of a single layer or plural layers.

12. The liquid crystal panel of claim 1, wherein the polarization rotating layer is a ½ wavelength plate.

13. The liquid crystal panel of claim 12, wherein the ½ wavelength plate has a refractive index property of any one of nx₁>ny₁>nz₁, nx₁>ny₁≅nz₁, and nx₁>nz₁>ny₁, where
nx₁ represents a refractive index in an X-axis direction in a plane of the ½ wavelength plate,
ny₁ represents a refractive index in a Y-axis direction in the plane, and
nz₁ represents a refractive index in a direction perpendicular to said X-axis direction and Y-axis direction, wherein
the X-axis direction is an axis direction in which the refractive index attains a maximum value in the plane, and
the Y-axis direction is a direction perpendicular to an X-axis in the plane.

14. The liquid crystal panel of claim 1, wherein the polarization rotating layer has a liquid crystal material that has been subjected to cholesteric orientation.

15. The liquid crystal panel of claim 14, wherein the polarization rotating layer contains 0.01 to 0.2 parts by weight of a chiral agent with respect to 100 parts by weight of a nematic liquid crystal material.

16. The liquid crystal panel of claim 1, wherein an optical compensating layer showing a predetermined retardation is disposed between the visible-side polarizer and the antivisible-side polarizer.

17. The liquid crystal panel of claim 16, wherein the optical compensating layer has a refractive index property of any one of nx₂>ny₂>nz₂, nx₂>ny₂ nz₂, and nx₂>nz₂>ny₂, where
nx₂ represents a refractive index in an X-axis direction in a plane of the optical compensating layer,
ny₂ represents a refractive index in a Y-axis direction in the plane, and
nz₂ represents a refractive index in a direction perpendicular to said X-axis direction and Y-axis direction, wherein
the X-axis direction is an axis direction in which the refractive index attains a maximum value in the plane, and
the Y-axis direction is a direction perpendicular to an X-axis in the plane.

18. A liquid crystal display device having the liquid crystal panel of claim 1.
